(19) United States
(12) Patent Application Publication
(10) Pub. No.: US 2011/0035340 A1
(43) Pub. Date: Feb. 10, 2011

(54) DECORATING SYSTEM AND METHOD OF MARKETING AND ENHANCING A SURFACE AREA USING A DECORATING SYSTEM

(75) Inventor: Donna Lichtenstein, Chicago, IL (US)

Correspondence Address: VEDDER PRICE P.C., 222 N. LASALLE STREET, CHICAGO, IL, 60601, US

(73) Assignee: FIBRE-CRAFT MATERIALS CORP., Niles, IL (US)

(21) Appl. No.: 12/537,939

(22) Filed: Aug. 7, 2009

(51) Int. Cl. G06Q 30/00; B44C 3/12; B32B 33/00; B32B 1/06; G06Q 90/00

(52) U.S. Cl. 705/500; 428/40.1; 428/35.2; 156/63; 705/27.1

(57) ABSTRACT

The present disclosure relates generally to a decorating system and a method of enhancing a surface using the decorating system, and more particularly, to a decorating system where decorative templates are used to help select foam elements from a plurality of nonplanar, scaled or unscaled foam elements, which are sold in a display or over the Internet, to be implemented on a wall surface or other room design elements. The decorating system includes a plurality of nonplanar foam elements having a flat side on which is affixed double-sided adhesive. The adhesive is covered with peel-off paper and the other side of the foam element is an outward shape used to create three-dimensional relief of design elements such as flowers, animals, letters, and the like.

### FIELD OF THE DISCLOSURE

The present disclosure relates generally to a decorating system and a method of enhancing a surface area using the decorating system, and more particularly, to a decorating system where decorative templates are used to help select foam elements from a plurality of nonplanar, scaled or unscaled foam elements, which are sold in a display or over the Internet, along with wall surface layering or other room design elements.

### BACKGROUND

To enhance living conditions in a residence, people use paint, carpet, wallpaper, designer furniture, and other smaller items such as frames and posters. Permanent or semipermanent decorative items, such as paint, lighting, and heavy furniture, are often expensive and cannot be changed frequently. Because children have rapidly evolving tastes, what was once a beloved room decor may be outgrown after a single season.

For example, parents often resort to the use of posters, lamps, or even drapes to revamp a child's room design when in fact a greater level of change is desired. By creating a new room decor, outdated furniture can be kept. Other people, in other areas such as businesses, hospitals, social service offices, day cares, etc. are also in need of enhances areas where permanent or semipermanent decorative items cannot be used freely. What is needed is a new decorating system that is inexpensive and can be implemented rapidly to prolong the useful life of furniture and enhance any area of interest.

Aesthetics is not the only reason why decoration is needed in areas of interest. Parents, educators, therapists, etc. need to stimulate a the imagination and creativity as part of good, ongoing work. Further, the importance of school and home craft projects designed to encourage and stimulate a child's mind is well known. Parents and teachers work with a child to create less-than-perfect works of art that may nonetheless accrue a priceless value. The design of a room is currently left to professionals. Television shows, at often great expense, invite designers to create surreal rooms for needy children. What is needed is an interactive craft-like room decorating system that allows parents or decorators to create and implement a new room design cheaply with the help of a child. What is also needed is a room decorating system that allows for a child's imagination and creativity to be stimulated.

Other areas of interest such as any commercial decor also can be optimized, changed, and decorated for a wide range of legitimate reasons. For example, sports courts, gymnasiums, garages, classes, churches, can be changed by individuals for a plurality of reasons. Even surface such as the inside of a vehicle, a gas tank on a scooter, an improvised social event, and the like can require touch-ups and aesthetic changes.

Current existing room enhancement systems and decor enhancement systems vary from posters to wall surface finishes depending on the surface area on which they are placed. A first system shown in FIGS. 1 and 2 places a plurality of magnetized planar decals (e.g., sea creatures) over a magnetic strip affixed to a wall (e.g., a sea color strip). This system, while capable of stimulating a child's imagination, is limited to a single theme and does not require much creativity to implement. A second system shown in FIGS. 3 and 4 is also formed by stacking several planar decals (e.g., a woodland scene). In this system, characters can be moved around within a frame. Once again, while this system is capable of some manipulation by a child, the product is purchased with a single theme and does not need creativity to implement. What is needed is a decorating system that is integrated within the entire surface area, that can operate in coordination with furniture, lighting, wall surface finishes, bed sheets, etc., and any other element found in the surface area and even act as a craft project or other pedagogical tool and exercise.

### SUMMARY

The present disclosure relates generally to a decorating system and a method of enhancing a surface using the decorating system, and more particularly, to a decorating system where decorative templates are used to help select foam elements from a plurality of nonplanar, scaled or unscaled foam elements, which are sold in a display or over the Internet, to be implemented on a wall surface or other room design elements. The decorating system includes a plurality of nonplanar foam elements having a flat side on which is affixed double-sided adhesive. The adhesive is covered with peel-off paper and the other side of the foam element is an outward shape used to create three-dimensional relief of design elements such as flowers, animals, letters, and the like.

### BRIEF DESCRIPTION OF THE DRAWINGS

The following disclosure as a whole may be best understood by reference to the provided detailed description when read in conjunction with the accompanying drawings, drawing description, summary, abstract, background of the disclosure, field of the disclosure, and associated headings. Identical reference numerals when found on different figures identify the same elements or functionally equivalent elements. The elements listed in the summary and abstract are not referenced but nevertheless refer by association to the elements of the detailed description and associated disclosure.

FIG. 1 is flat, wall decorating system from the prior art.

FIG. 2 is cut-out view of the flat, wall decorating system from the prior art along line 2-2 as illustrated in FIG. 1.

FIG. 3 is a flat, removable scene-scape bordered by an interchangeable window frame for decorating the wall of a surface according to another embodiment from the prior art.

FIG. 4 is a cut-out view of the flat, removable scene-scape bordered by an interchangeable window frame for decorating the wall of a surface from the prior art long line 4-4 as illustrated in FIG. 3.

FIG. 5 is an illustration of the corner of a surface decorated with the decorating system according to an embodiment of the present invention.

FIG. 6 is a side view taken along cut line 6-6 as shown in FIG. 5 to better illustrate the three-dimensional features of the different design elements within the decorating system according to an embodiment of the present disclosure.

FIG. 7 is a close-up view of one of the design elements shown in FIG. 6 according to an embodiment of the present disclosure.

FIG. 8 is an illustration of a room before it is decorated with the decorating system according to another embodiment of the present disclosure.

FIG. 9 is an illustration of the surface area shown in FIG. 8 after it has been decorated with the decorating system according to a method of enhancing a surface area using the decorating system according to another embodiment of the present disclosure.

FIG. 10 is a partial cut perspective illustration of a display stand to market the decorating system as used within a method of marketing the decorating system according to another embodiment of the present disclosure.

FIG. 11 is a side view of a foam element according to an embodiment of the present disclosure.

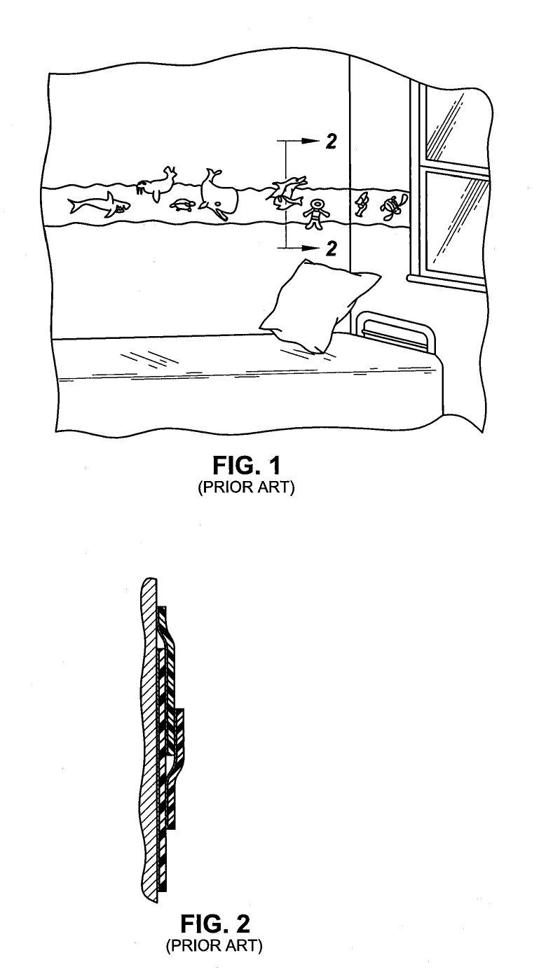

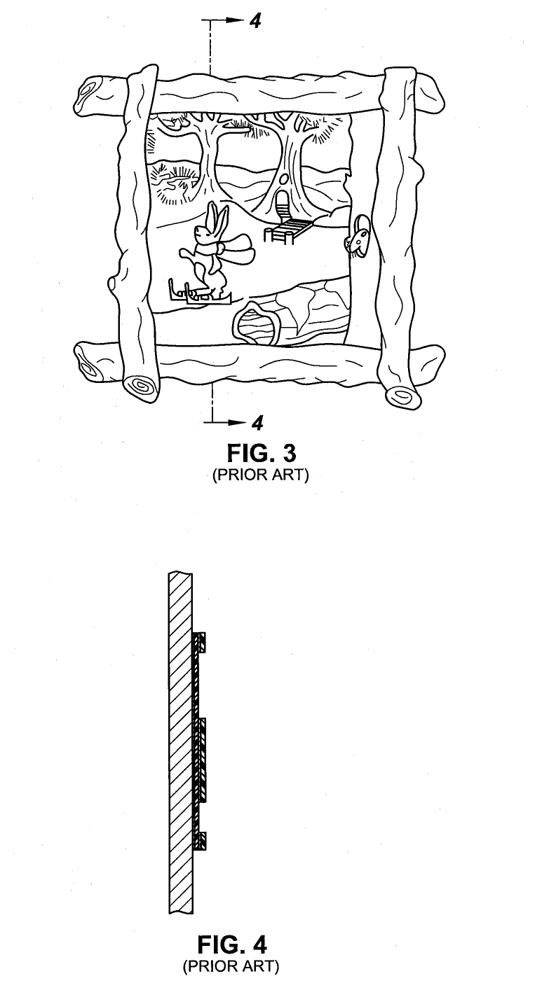

### DETAILED DESCRIPTION

For the purposes of promoting and understanding the invention and principles disclosed herein, reference is now made to the preferred embodiments illustrated in the drawings, and specific language is used to describe the same. It is nevertheless understood that no limitation of the scope of the disclosure is thereby intended. Such alterations and further modifications in the illustrated devices and such further applications of the principles disclosed as illustrated herein are contemplated as would normally occur to one skilled in the art to which this disclosure relates.

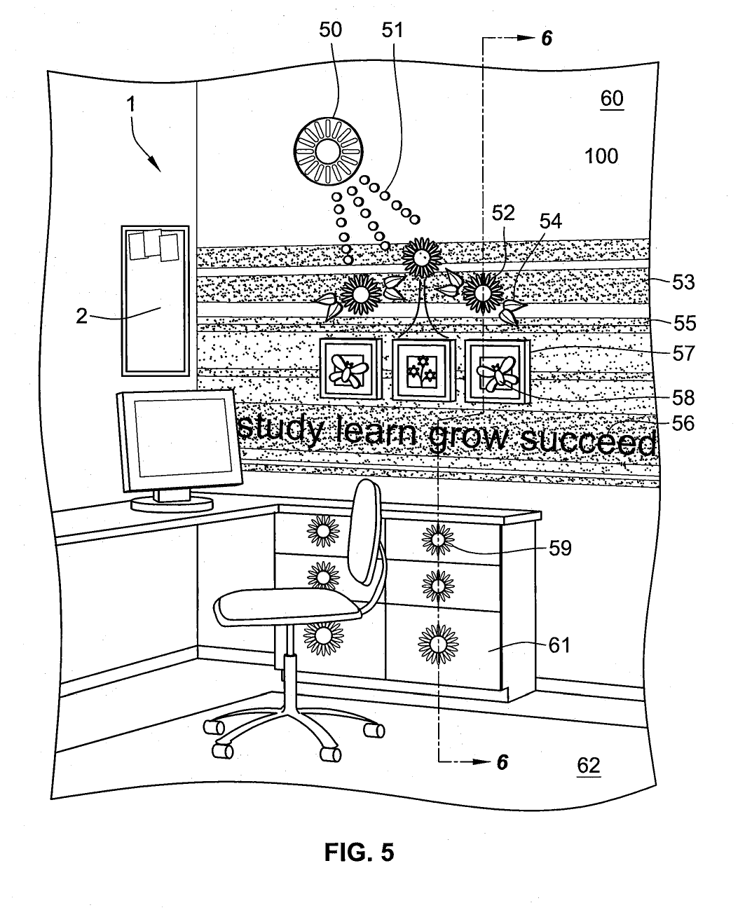

FIG. 5 is an illustration of a room 100 decorated with the decorating system 1 according to an embodiment of the present invention. The room 100 as shown includes a back wall 60 and a floor 62 as a possible embodiment of a room. Furniture 61 is placed in the room, such as a desk and a chair. Other decorative elements, such as frames 57 and a white board 2, can be attached to the walls. FIG. 5 shows a room 100 where horizontal strips of paint or wallpaper 53, 55 of two different colors are placed on the wall 60. Small frames 57 are shown above the decorative wall covering. While a room is shown at FIG. 5, what is contemplated is the use of the decorating system 1 on any surface area, any area, any object having an external surface that may be enhanced using the decorative system, such as for example business areas, cafeterias, schools, hospitals, social services, day cares, etc. In addition, the decorating system 1 can also be used on any surface of any element, such as furniture, vehicles, clothing, and the like. For example, children may purchase known design elements to held decorate a school locker, a lunch box, a bedroom, etc.

The room decorating system 1 includes a plurality of foam elements shown as 50, 51, 52, 54, 58, and 59 in FIG. 5. As shown in FIGS. 7 and 11, each element 52 is generally nonplanar, having a first flat side 400 shown in FIG. 7 resting against the wall 60, and in opposition to the first flat side 400 a second nonplanar side 401 having an outward shape such as the rounded shape of a flower for displaying a design element such as a flower. Returning to FIG. 5, a first foam element 50 can represent a sun, and smaller colored dots 51 can be used to simulate rays of sunshine directed at other foam elements 52, 54 representing sunflowers and their leaves. In FIG. 5, a template was used and smaller-scale, flower-shaped foam elements 59 can be placed on the furniture 61. A foam element 58 representing a small butterfly is also placed on the frame 57 to further enhance the overall decor of the room. Finally, other foam elements in the shape of letters can be placed on the wall 60 or as shown, the letters can be painted directly onto the wall 60. In the example shown in FIG. 5, the study room in enhanced to improve the atmosphere that can result from a computer screen and the absence of natural light. The use of an exterior scene can enhance the decor of a surface area. While opaque foam elements 58 are shown, what is contemplated is the use of any element 58 of foam or many of any other material, with a semi-opaque, transparent, semi-transparent, luminescent, or any other surface property for the aesthetic enhancement created by the element 58. The term foam element is to be construed as any element made with any material, having any surface finish, designed to create a 3D effect on the design element to which the element 58 is placed.

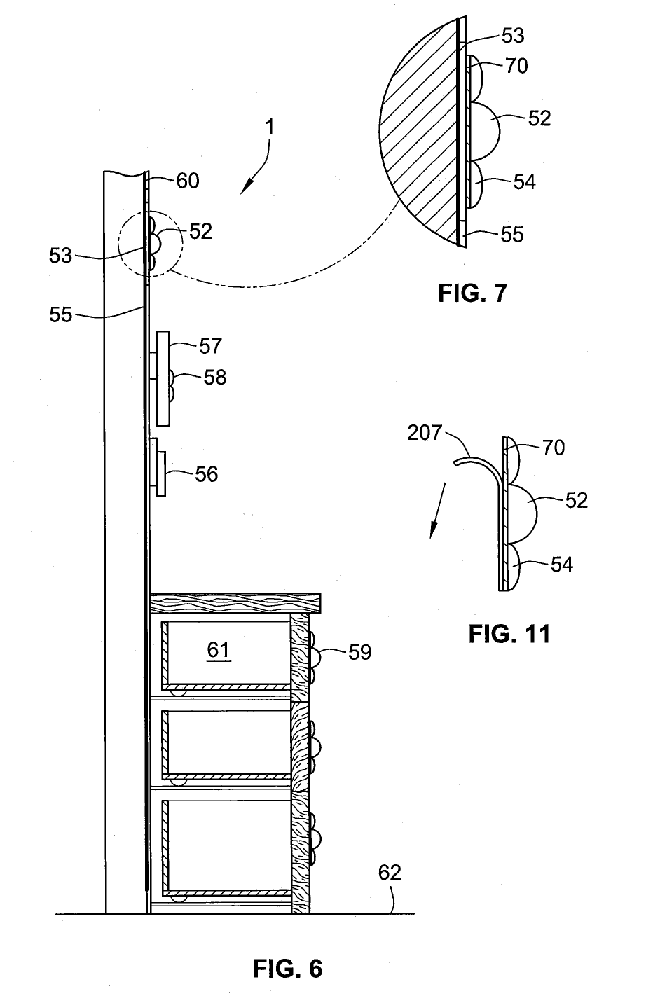

FIG. 6 is a side view taken along cut line 6-6 as shown in FIG. 5 to better illustrate the three-dimension features of the different design elements within the decorating system 1. In FIG. 6, the side view illustrates the depth of the letters 56, the small butterfly 58 attached to the frame 57, and the top sunflower 52 placed over a portion of the wall covering 53. In the close-up of FIG. 7, a layer of adhesive 70 is placed on the wall 60 or as shown on the wall covering 53. In FIG. 11, a layer of peel-off paper 207 is placed over the double-sided adhesive layer 70 to protect the foam element 52. What is contemplated is the use of an adhesive 70 of sufficient grip for the foam element 52 to be glued on a surface, such as the wall 60, the wall covering layer 53, or a piece of furniture 61.

The double-sided adhesive layer 70 has a first side 500 in contact with the first flat side 400 of the foam element 50, 51, 52, 54, 58, and 59, and a second side 501 in contact with a manual peel-off layer 207 for manual removal from the double-sided adhesive layer as shown in FIG. 11 by the arrow. The second side of the adhesive layer 501 is adapted to be mounted on a first surface to be decorated in a room once the peel-off layer 207 is removed. One of ordinary skill in the art will recognize that different adhesive technologies can be used to adhere different foam elements to different surfaces to prevent them from peeling off or from damaging the wall surface if and when they are ultimately removed. The use of permanent and impermanent adhesives is also contemplated.

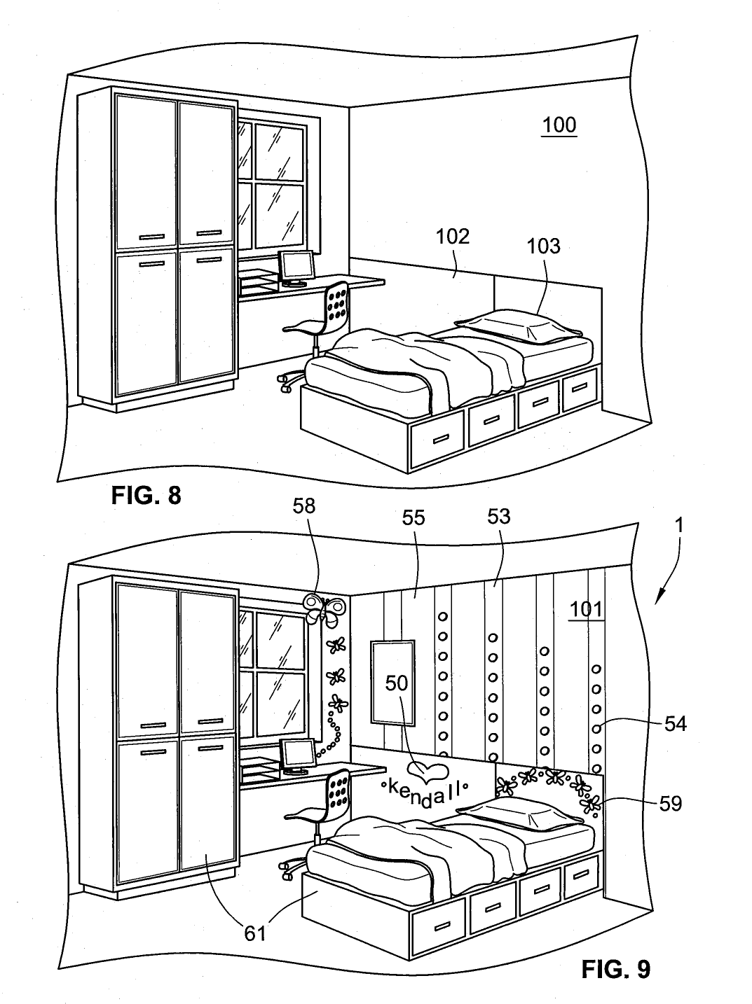

FIGS. 8 and 9 show a room before and after it is decorated using the decorating system 1. In FIG. 8, the surface area includes walls 100, furniture such as a bed 103, and wall protectors 102, a desk and a dresser. In FIG. 9, the decorated wall 101 is decorated using a design template to place strips of wall surfacing layers 53 such as paint or motif wallpaper above the bed area between other portions 55 of the wall 101. In this example, a series of nonplanar butterflies of different sizes 58, 59 are placed on the furniture and wall, and other foam elements such as a heart and letters 50 are placed on the board 102.

To transform a room or any other surface area as shown in FIG. 8 into a room or surface area decorated using the decorating system 1, a first of the plurality of foam elements is adapted to be mounted on a first surface to be decorated in the area, and a second foam element of the plurality of foam elements is adapted to be mounted on a second surface to be decorated in the area, and wherein said foam elements are arranged in a spatial arrangement within the room based on a decorative template. For example, in FIG. 9, the large butterfly 58 may be mounted on the wall next to the window and the heart 50 can then be mounted on the wall 101 as a second surface. Other foam elements, such as the small butterflies 59 and the letters illustrating the name KENDALL, are also decorative elements made of foam elements.

The foam elements include an outward shape in the form of a three-dimensional rendering of the design element. For example, FIG. 7 shows how a flower can have a rounded internal portion and rounded petals. FIG. 6 shows how letters 56 may be made using a square design element of uniform thickness. A wall surfacing layer having a first color placed in the room can be color coordinated with the design element of one of the foam elements. Many different shapes and design elements can be used with the decorating system 1, for example small vehicles, fairy tale elements, sporting elements, floral elements, sports elements, glitzy elements, neonatal elements, sea related elements, safari related elements, fantasy characters, pirate scene elements, seasonal elements, holiday specific elements. What is also contemplated is the use of licensed elements from known characters, movies, or entertainment sources.

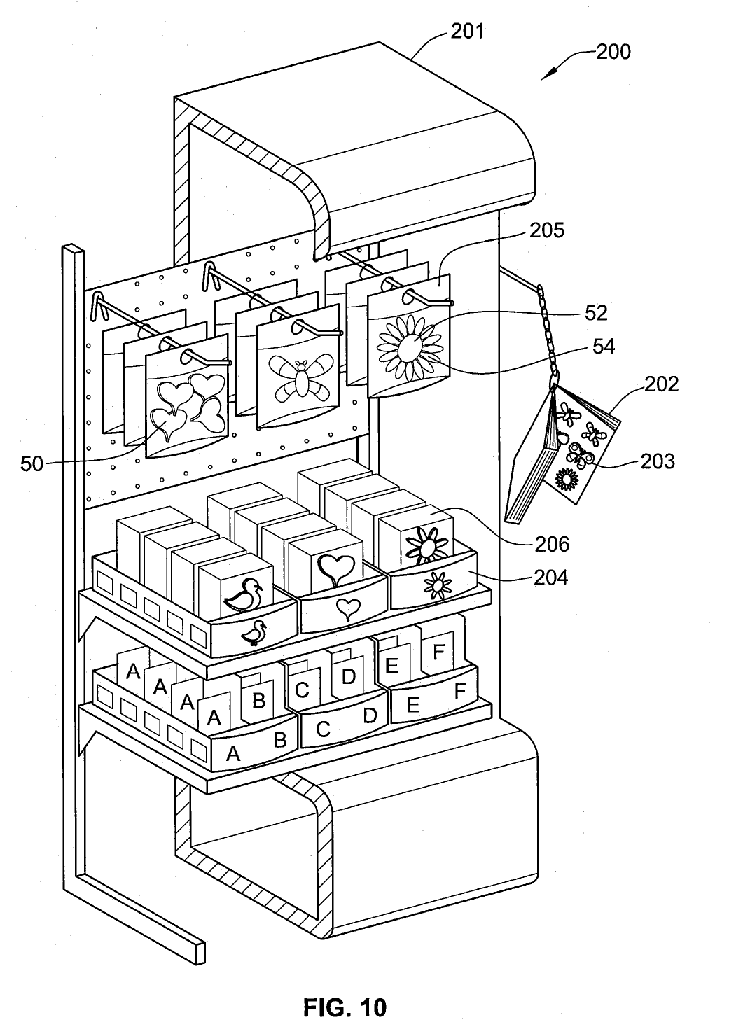

FIG. 10 shows a display 200 utilizing a plurality of sealed pouches 205, each for holding at least one of the plurality of foam elements 52, 54, and 50. Other holder devices 204, such as racks, can be made to hold other pouches or boxes 206 (as shown) with the foam elements. Other holder devices shown on the lower level of the display 200 hold foam elements in the shape of letters for writing names or other words on the walls of surface elements.

What is also contemplated is a method of enhancing a surface area using a decorating system 1 where a user first selects and acquires a plurality of sealed pouches 205 as shown in FIG. 10 for a surface to be enhanced. Once returned in the vicinity of the surface area to be decorated, the sealed pouches are opened, the foam elements are removed from the pouches, and the protective peel-off sheet is removed from the opposite side of the foam elements before the elements are ultimately placed upon a first surface in the surface area to be enhanced.

What is also contemplated is the use of either a physical store, such as a craft store or a craft section within a larger sales space, or an online store operating through a website or a web reseller. As part of this method, a user can further select and acquire a wall surfacing layer and place the wall surfacing layer on at least a surface in the area to be enhanced and where the different foam elements can be placed on walls, ceilings, floors, furniture or any other surface where decorative elements can be attached.

In yet another embodiment, the method of marketing a room decorating system 1 includes a plurality of foam elements on display at a location and then to provide guidance and decorative ideas, such as through the use of an attached catalog 202 with a plurality of templates 203 as shown in FIG. 10, for using different foam elements within a surface area to be enhanced. In yet another embodiment, if an online store is used to market and sell the pouches containing decorative foam elements, the decoration templates can be provided to the user in the form of an electronic file shown to the user using an Internet website before the user is conducted through an online purchasing process. In another contemplated embodiment, the display 200 is a physical store, the templates are provided via a television broadcast, such as a description of the product in a design television show, and the purchase by the user is conducted at the physical location of the store. Finally, a small TV monitor equipped with a device to play in loop a television show or other advertising clip for the display of sample design templates can be placed at the physical store in proximity to the display 200. While a handful of methods of providing templates along with the room enhancement system are disclosed, what is contemplated is any known advertising and marketing method used in tandem with the sale of a packaged system made of a plurality of different elements to be coordinated along with a room or surface area enhancement using templates.

Persons of ordinary skill in the art appreciate that although the teachings of the disclosure have been illustrated in connection with certain embodiments, there is no intent to limit the invention to such embodiments. On the contrary, the intention of this application is to cover all modifications and embodiments falling fairly within the scope of the teachings of the disclosure.

What is claimed is:

1. A decorating system comprising:
a plurality of foam elements each element being generally nonplanar and having a first flat side and in opposition to the first flat side a second nonplanar side with an outward shape for displaying a design element, a double-sided adhesive layer where a first side of the adhesive layer in contact with the first flat side of the foam element, and a second side of the adhesive layer in contact with a manual peel-off layer for manual removal from the double-sided adhesive layer, and wherein the second side of the adhesive layer is adapted to be mounted to on a first surface to be decorated in a surface area once the peel-off layer is removed, and
a first of the plurality of foam elements is adapted to be mounted on a first surface to be decorated in the surface area, and a second foam element of the plurality of foam elements is adapted to be mounted on a second surface to be decorated in the surface area, and wherein said foam elements are arranged in a spatial arrangement within the surface area based on a decorative template.

2. The decorating system of claim 1, wherein the surface area is a room.

3. The decorating system of claim 1, wherein the outward shape is in the form of a three-dimensional rendering of the design element.

4. The decorating system of claim 3, further comprising a wall surfacing layer with a color placed in the surface area where at least a design element of one of the foam elements is in color coordination with the color of the wall surfacing layer.

5. The decorating system of claim 4, wherein the wall surfacing layer is one of a layer of paint or an adhesive wallpaper.

6. The decorating system of claim 1, wherein the system further comprises a plurality of sealed pouches, each for holding at least one of the plurality of foam elements.

7. The decorating system of claim 1, wherein the system further includes at least a design element having a different scale on at least two of the foam elements as part of the decorative template.

8. The decorating system of claim 1, wherein the outward shape is a letter of the alphabet or a numeral.

9. A method of enhancing a surface area using a decorating system comprising a plurality of foam elements each having a first flat side and in opposition a second side with an outward shape for displaying a design element, wherein the first flat side is adapted to receive an adhesive sheet placed on one side in contact with the first flat side, and on the opposite side in contact with a protective peel-off sheet, and wherein the system further comprises a plurality of sealed pouches, each for holding at least one of the plurality of foam elements, the method comprising the steps of:
selecting and acquiring from a location a plurality of sealed pouches for a surface area to be enhanced, and in any order,
opening the sealed pouches,
removing the foam elements from the pouches,
removing the protective peel off sheet from the opposite side of the foam elements,
placing upon a first surface in the surface area to be enhanced at least a foam element, and
placing upon a second separate surface in the surface area to be enhanced at least another foam element.

10. The method of claim 9, wherein the location is either a physical store or an online store.

11. The method of claim 9, further comprising the steps of further selecting and acquiring a wall surfacing layer, and placing the wall surfacing layer on at least a surface in the surface area to be enhanced.

12. The method of claim 11, wherein the at least a surface in the surface area is either the first surface or the second separate surface.

13. The method of claim 11, wherein the first surface is a wall and the second separate surface is a piece of furniture.

14. A method of marketing a decorating system comprising a plurality of foam elements, each having a first flat side and in opposition a second side with an outward shape for displaying a design element, wherein the first flat side is adapted to receive an adhesive sheet placed on one side in contact with the first flat side, and on the opposite side in contact with a protective peel off sheet, and wherein the system further comprises a plurality of sealed pouches, each for holding at least one of the plurality of foam elements, the method comprising the steps of:
displaying at a location a display with a plurality of sealed pouches for displaying a plurality of different foam elements;
providing guidance with sample decorative templates for using different foam elements within a surface area to be enhanced; and
providing for purchase by a user a plurality of sealed pouches.

15. The method of marketing the decorating system of claim 14, wherein the sample decoration templates are provided to the user in the form of a physical catalog.

16. The method of marketing the decorating system of claim 14, wherein the location of the display is an website on the Internet, the templates are Internet links to images, and the purchase by the user is conducted through an online purchasing process.

17. The method of marketing the decorating system of claim 14, wherein the location of the display is a store, the templates are provided via a television broadcast, and the purchase by the user is conducted at the physical location of the store.

18. The decorating system of claim 1, wherein the surface area is a surface selected from a group consisting of a business area, a cafeteria, a school, a hospital, a social service, a day care, a piece of furniture, a vehicle, clothing, a school locker, a lunch box, and a bedroom.

19. The decorating system of claim 1, wherein the foam elements are made of a material selected from a group consisting a semi-opaque material, an opaque material, a transparent material, a semi-transparent, and a luminescent material.

20. The decorating system of claim 1, wherein the decorative template is selected from a group consisting of a vehicle, a fairy tale, a sport, a floral landscape, a glitzy scene, a neonatal template, a sea related template, a safari scene, a fantasy template, a pirate template, a seasonal template, a holiday specific template, a licensed known character, a licensed movie, and an entertainment license.
